(19) United States
(12) Patent Application Publication
(10) Pub. No.: US 2013/0331162 A1
(43) Pub. Date: Dec. 12, 2013

(54) MATCH THREE GAMING SYSTEM AND METHOD

(71) Applicants: Alexander Higgins Krivicich, Santa Monica, CA (US); Kevin Tyler John, Los Angeles, CA (US); Tamar Erin Curry, Culver City, CA (US); David Jeffrey Barlia, Pasadena, CA (US); Michael David Fogg, Beverly Hills, CA (US); Matthew Jacob Palmer, Los Angeles, CA (US); Herbert Carl Goss, Los Angeles, CA (US); Nicola Geretti, Los Angeles, CA (US)

(72) Inventors: Alexander Higgins Krivicich, Santa Monica, CA (US); Kevin Tyler John, Los Angeles, CA (US); Tamar Erin Curry, Culver City, CA (US); David Jeffrey Barlia, Pasadena, CA (US); Michael David Fogg, Beverly Hills, CA (US); Matthew Jacob Palmer, Los Angeles, CA (US); Herbert Carl Goss, Los Angeles, CA (US); Nicola Geretti, Los Angeles, CA (US)

(21) Appl. No.: 13/494,941

(22) Filed: Jun. 12, 2012

(51) Int. Cl. A63F 13/00

(52) U.S. Cl. 463/10; 463/9; 463/36

(57) ABSTRACT

A gaming system, comprising a graphic user interface generated by a processor for a display device, the graphic user interface further comprising a field having a N×M matrix of spaces, wherein N and M are integers greater than three, and wherein each space of the matrix includes one of a plurality of different items. A cursor having an associated item and configured to allow a user to exchange a selected item from the field with the cursor item. Wherein forming a predetermined arrangement of three or more identical items results in the items within the arrangement being removed from the field.

### TECHNICAL FIELD

The present disclosure relates to gaming systems, and more specifically to a match three gaming system and method of operation.

### BACKGROUND OF THE INVENTION

Match three games involve matching three items in a field of items. When a match is obtained, the items are typically removed from the field, and play continues until all items are removed from the field.

### SUMMARY OF THE INVENTION

A gaming system is provided that includes graphic user interface generated by a processor for a display device, where the graphic user interface further includes a field having a N×M matrix of spaces, wherein N and M are integers greater than three, and wherein each space of the matrix includes one of a plurality of different items. For example, an eight by eight matrix can be generated that has 64 items, where one item is shown in each space of the matrix, and where each of the items in the 64 spaces are selected from a set of six possible gems, such as a diamond and a water drop. A cursor having an associated item allows a user to exchange a selected item from the field with the cursor item, such as where the cursor item is a diamond and the selected item from the field is a water drop, such that the cursor item becomes the water drop and the field item becomes the diamond. Forming a predetermined arrangement of three or more identical items, such as three diamonds in a vertical or horizontal row, results in the items within the arrangement being removed from the field.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a display for a match three game in accordance with an exemplary embodiment of the present disclosure;

FIG. 2 is a diagram of an algorithm for controlling a game in accordance with an exemplary embodiment of the present disclosure;

FIG. 3 is a diagram of an algorithm for challenge mode gaming in accordance with an exemplary embodiment of the present disclosure;

FIG. 4 is a diagram of an algorithm for tournament mode gaming in accordance with an exemplary embodiment of the present disclosure; and

FIG. 5 is a diagram of a system for controlling a game in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

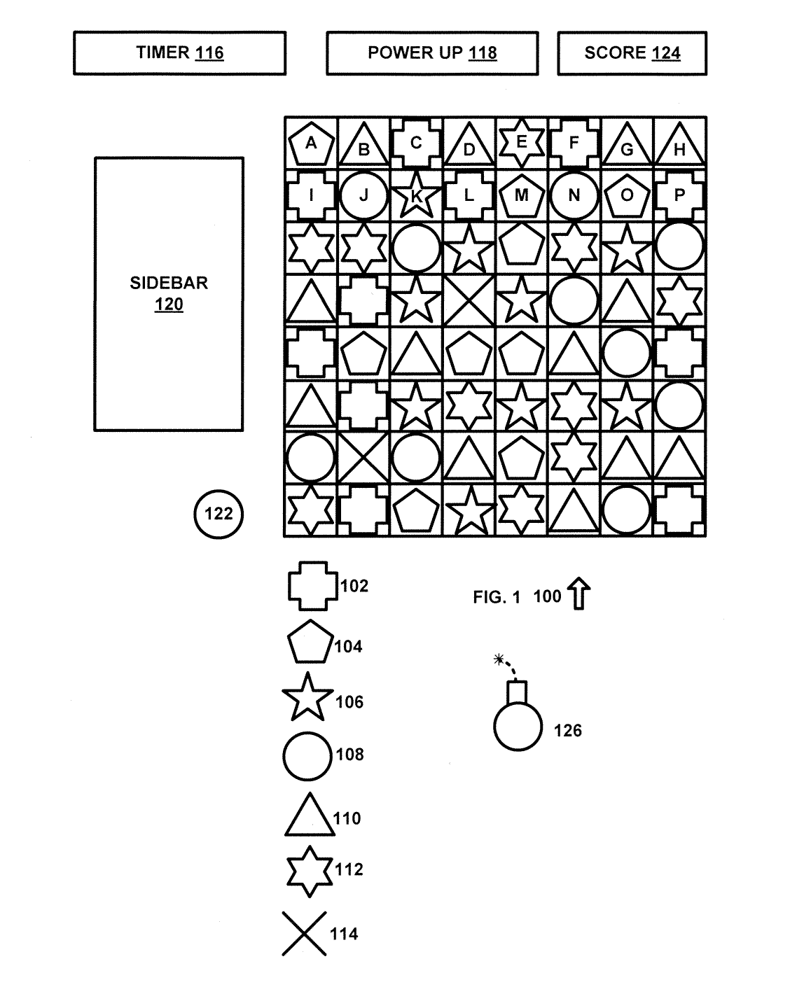

FIG. 1 is a diagram of a display 100 for a virtual match three game in accordance with an exemplary embodiment of the present disclosure. A used herein, “virtual” refers to computer simulated spaces, objects or other suitable computer simulations, such as a virtual lobby, a virtual world, a virtual room, a virtual item, a virtual bomb, virtual currency, or other suitable constructs. Display 100 can be generated as a graphic user interface on a screen of a general purpose computer, a computer network, a cellular telephone, a tablet computer, a notebook computer, a personal gaming device or other suitable systems, and can be implemented in hardware or a suitable combination of hardware and software, such as one or more software systems operating on a processor. In addition to a processor, user interface devices such as a touch screen interface, a keyboard, a mouse, a stylus, a voice response system utilizing a microphone and voice processing system or other suitable user interface devices can be provided. Data memory devices can be provided for storing one or more algorithms for generating display 100 and controlling the functionality of display 100 as described herein. The data memory devices can be configured to provide permanent or transient electronic, optical, magnetic or other suitable data storage. Additional data interface devices such as USB ports, fire wire ports, serial ports, PCI ports or other suitable data interface devices can also be provided.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Display 100 includes a field that comprises an eight by eight matrix of spaces. In one exemplary embodiment, the field can be implemented as algorithms, as one or more objects for each space having graphical, data and operational attributes or in other suitable manners. Display 100 includes a plurality of instances of items, such as cross item 102, pentagram item 104, five point star item 106, circle item 108, triangle item 110, six point star item 112 and X mark item 114. Likewise, gems, colors, pictures, figures, or other suitable items can be used to populate the field and for game play. The items can be randomly generated at the start of a gaming session, can be assigned in a predetermined configuration, or other suitable processes can also or alternatively be used.

Display 100 also includes timer display 116, power up display 118 and sidebar display 120, each of which can be implemented as algorithms, as one or more objects having graphical, data and operational attributes, or in other suitable manners.

In one exemplary embodiment, display 100 can be used to implement a match three game. At the start of the match three game, the field can be randomly populated with items in each of the 64 spaces of the field, and timer display 116 can be a countdown timer that is initiated with a predetermined period of time, such as one minute, a move counter that is initiated with a predetermined number of available moves (such as where each swap of a cursor item with a field item or each placement of a bomb item constitutes a move), such as 30 moves, or in other suitable manners. A cursor item 122, which can be implemented as one or more objects having graphical, data and operational attributes, can be generated having a randomly selected item, such as circle item 108 as shown. The user can move cursor item 122 using the user interface device so as to place cursor item 122 over an item in one space of the field, and can activate a control to cause the item in the selected field space to be replaced with the cursor item, and to cause the cursor item to be replaced with the corresponding item from the field space, such as by selecting a control on the user interface device, by tapping a touch screen interface, or in other suitable manners. In this exemplary embodiment, cursor item 122 can be placed over the field space containing the triangle B item, and can be activated to cause the triangle B item to be replaced with a circle item, and to cause the circle item that is currently cursor item 122 to be replaced with a triangle item. The user can then move the cursor item 122 (which is now a triangle item) over the field space containing the cross F item, and can activate the cursor control to replace the cross F item in the field space with a triangle, so as to form a line of three triangle items in the three adjacent field spaces (i.e., new triangle item F and existing triangle items G and H).

After a line of three triangle items has been formed in this manner, the items can be removed from the field spaces. In one exemplary embodiment, each space in the field can be implemented as an object having graphical, data and operational attributes, such as object item type attributes that identify the item type that is presently represented in the space, graphical attributes that generate a graphical image associated with that item type, and operational attributes for monitoring the object item type attributes in adjacent field spaces. In this exemplary embodiment, when a center field space object detects that the field space objects to the left and right of the center field space object have the same object item type attribute as the center field space object, the center field space object can activate an operational attribute for all three field space objects to cause the field space objects to change to an empty object item type state. Likewise, each field space object in the field can have operational attributes that cause the field space objects to interact with adjacent field space objects to simulate movement of the items adjacent to the empty spaces into the empty spaces, and to change their state to empty space states. In this exemplary embodiment, each object can have operational attributes that are modeled in pseudo code as follows:

10 if field space object below has empty space item type, transmit item type attribute to field space object below

20 change item type attribute to empty space

In this manner, when a line of three matching items occurs, the three matching items will appear to be removed from the field to form empty spaces, and the items above the three empty spaces will appear to cascade down to fill in the empty spaces.

Likewise, when a field space object at the top of the field changes state to an empty object item type, a new item type can be randomly generated for that field space object, so as to maintain an item in each space of the field.

Likewise, in addition to removing a horizontal line of three adjacent identical items, a vertical line of three adjacent identical items, a vertical or horizontal line of four or more adjacent identical items, or other suitable configurations of items can be removed in a similar manner.

In another exemplary embodiment, a class of items can be excluded from the match three removal process, such as X mark item 114. In this exemplary embodiment, when a field space object has an X mark item attribute, the operational attribute for monitoring for identical adjacent field space object item attributes can be suspended. In addition, when field space objects at the bottom of the field change to an X mark item attribute, those field space objects can have an additional operational attribute that causes the field space objects to change to an empty space attribute, to change to an empty space attribute if there is one or more adjacent field space objects with X mark item attributes, or in other suitable manners.

In addition, for field space objects with an X mark item attribute, the cursor exchange operational attribute can also be excluded, such as to prevent the cursor item 122 from being exchanged with an field space object having an X mark item attribute.

Power up display 118 can be used to provide an additional cursor item 122 for placement in the field. In one exemplary embodiment, power up display 118 can be implemented as an object having graphical, data and operational attributes, such as an operational attribute that monitors field space objects, score display 124 or other suitable data or objects to determine if matching items have been removed. As matching items are removed, a progress indicator graphical attribute of power up display 118 can be modified to represent the progress towards obtaining an in-game power up award. In one exemplary embodiment, the in game power up award can be a bomb item 126 that can be placed in a field space object and which causes a predetermined number of item attributes for adjacent field space objects to be changed to an empty space attribute, such as to simulate the destruction of the items in those field spaces. Bomb items 126 can be implemented as one or more objects that have graphical, data and operational attributes. In this exemplary embodiment, a user can earn or purchase different types of bomb items, such as bombs items that destroy left adjacent field space object items, right adjacent field space object item attributes, left and right adjacent field space object item attributes, top adjacent field space object item attributes, bottom adjacent field space object item attributes, top and bottom adjacent field space object item attributes, or other suitable combinations of field space object item attributes. In another exemplary embodiment, a bomb object can have no effect on field space objects having an X mark item attribute.

Sidebar display 120 can be implemented as one or more objects having graphical, data and operational attributes that are used to generate a game data display as a function of a mode of play. In one exemplary embodiment, sidebar display 120 can generate a status indicator for a challenge mode of play that shows a player's progress through a number of challenge mode objectives. In this exemplary embodiment, challenge mode can have an associated architecture for allowing a user to progress through challenge mode, such as a predetermined number of worlds, where each world has a predetermined number of levels, and each level has a predetermined number of objectives. Each objective, such as a star, can be achieved by playing the match three game and obtaining the objective, such as by eliminating a predetermined number of items, a predetermined number of a predetermined type of item, or other suitable objectives. In another exemplary embodiment, sidebar display 120 can generate a status indicator for a tournament mode of play, such as a status indicator that shows the player's relative standing in relation to a set of other players that have been selected for a tournament.

Score display 124 can be implemented as one or more objects having graphical, data and operational attributes that are used to generate scoring data. In one exemplary embodiment, users can be awarded points for each item that is removed by forming a match, points for each item that is removed by using a bomb item, points for each X mark item that is removed when it reaches the bottom row of the field, or points for other suitable game conditions. In this exemplary embodiment, points can be multiplied as a function of game conditions, such as by obtaining a predetermined number of matches within a predetermined period of time. For example, if a player removes three sets of three items within a ten second time period, then a point multiplier of two can be applied for items that are removed during the next ten second time period. If the player removes five sets of three items within a ten second time period, then a point multiplier of three can be applied for items that are removed during the next ten second time period. Likewise, multipliers can be awarded for clearing sets of four or more items, for removing a total number of items regardless of whether they are removed by matching or with a bomb, or in other suitable manners.

FIG. 2 is a diagram of an algorithm 200 for controlling a game in accordance with an exemplary embodiment of the present disclosure. Algorithm 200 can be implemented in hardware or a suitable combination of hardware and software, such as one or more software systems operating on a general purpose processing platform.

Algorithm 200 begins at 202, where a specialist is selected. In one exemplary embodiment, a graphic user interface can be generated that allows a user to select one or more specialists that provide one or more predetermined gaming advantages after game play is initiated. In this exemplary embodiment, each specialist can be purchased using in game currency, can be selected from an available set of specialists, or can be selected in other suitable manners. Specialists can provide advantages for use in a match three type game, such as:

Providing a graphic enhancement to highlight available matches using the current cursor item

Providing an enhancement to the number of items that will be destroyed if a bomb is used

Providing additional game time to the countdown timer

Providing a multiplier for points earned during game play

Causing items adjacent to matched items to be destroyed/removed from the field

Accelerating the rate of power up charging

After one or more specialists are selected by the user, the algorithm can apply the specialist ability, such as by modifying the operational attributes of one or more objects in display 100 to implement the selected specialist advantage. The algorithm then proceeds to 204.

At 204, the game field is populated with items. In one exemplary embodiment, each space of the game field can be implemented as one or more objects having graphical, data and operational attributes, and can include an item type attribute that is randomly selected from a predetermined set of item types, such as those shown in display 100 or other suitable items types. Likewise, the graphical attribute for each field space object can be determined as a function of the item type attribute, or in other suitable manners. In another exemplary embodiment, a predetermined item distribution can be used, such as for tournament mode operation, to allow multiple players to compete against each other by playing a game having the same features. After the game field is populated with items, the algorithm proceeds to 206.

At 206, a timer is initiated. In one exemplary embodiment, the timer can be implemented as one or more objects having graphical, data and functional attributes, such as a data attribute for a predetermined initial amount of time, an operational attribute to allow the timer to be paused, or other suitable attributes. After the timer is initiated at 206, the algorithm proceeds to 208.

At 208, a user swaps a cursor item with a selected item. In one exemplary embodiment, the cursor can be implemented as one or more objects having graphical, data and operational attributes, and can include an item type attribute that can be randomly generated at the start of a game, that can be predetermined, or that can be assigned in other suitable manners. The cursor object can have operational attributes that allow the cursor to be moved within display 100, such as by using a touch screen interface, a mouse, a stylus, or other suitable user interface devices. When a user places the cursor over a field space object having an associated item, the user can activate a user control to cause an operational attribute of the cursor object, the field space object or other suitable objects or systems to exchange the item type attribute of the cursor with the item type attribute of the field space object, so as to swap the cursor item with the field space item. For example, if the cursor item is a cross item 102 and the field space object item is a circle item 108 as shown in display 100, activation of the cursor control can cause the cursor item to be changed to a circle item 108 and the field space object item to be changed to a cross item 102, such as by changing a item type data attribute of the cursor object and the field space object, or in other suitable manners. The algorithm then proceeds to 210.

At 210, it is determined whether three or more matching items are located in a line or other suitable configurations within the field. In one exemplary embodiment, each field space object can include operational attributes that compare the item type attribute of the field space object with the item type attribute of adjacent field space objects or other suitable configurations of field space objects. If it is determined that three or more matching items are located in a line or other suitable configurations within the field, the algorithm proceeds to 212, otherwise, the algorithm proceeds to 220.

At 212, the matching items are eliminated. In one exemplary embodiment, each field space object containing a matching item can execute an operational attribute that generates an animation or other suitable graphic displays that cause the item graphic within the field space to disappear, such as to momentarily create the appearance of an empty space. In addition, a score object or other suitable algorithms can be incremented to award the player with points for the elimination of the items, such as one point for each eliminated item, a point multiplier for each eliminated item, a point multiplier for each eliminated item in excess of three, or other suitable point awards. In addition, a specialist algorithm that causes items adjacent to the matching items to be eliminated, that causes a power up metric to be accelerated, or other suitable algorithms can also or alternatively be implemented. The algorithm then proceeds to 214.

At 214, items are shifted into the open spaces. In one exemplary embodiment, each field space object can include an operational attribute that monitors an item type attribute of one or more adjacent field space objects, such as field space objects located directly underneath the field space object. If the operational attribute of a first field space object determines that a second adjacent field space object represents an empty space, then operational attributes of the first field space object, the second field space object or other suitable objects or algorithms can cause the item type attribute of the first field space object and the second field space object to be exchanged, such as to swap the empty space item type attribute of the second field space object with the item type attribute of the first field space object. In this exemplary embodiment, each item of the field that is directly above an empty field space will appear to shift downwards one space. Likewise, lateral shifts, diagonal shifts, random shifts or other suitable shifts can also or alternatively be utilized. The algorithm then proceeds to 216.

At 216, new items are added to any remaining empty spaces. In one exemplary embodiment, after field items have been shifted to fill in the empty spaces created after matching items have been removed, empty spaces will exist at a border of the field, such as the top border if a downward shift is used, the left border if a right shift is used, and so forth. New items are added to these empty spaces, such as by randomly selecting an item type attribute for each empty field space object, by assigning a predetermined item type attribute to each empty field space object, by applying a specialist operational attribute to assign a special item type attribute to the empty field space object (such as a treasure item, a collection item or other suitable items), or in other suitable manners. In this exemplary embodiment, a treasure item can provide in game awards, such as additional points, in game currency, or other suitable awards, based upon one or more predetermined conditions, such as if the treasure item is destroyed by a bomb, if the treasure item is successfully migrated to the opposite field border, or in other suitable conditions. A collection item can provide in game advantages in combination with other collection items, such as by allowing the user to access additional virtual gaming areas or “rooms” upon acquisition of a complete set of collection items, by providing a points multiplier upon acquisition of a complete set of collection items, or in other suitable manners. After new items have been added to empty spaces, the algorithm proceeds to 218.

At 218, it is determined whether a new match of three or more items has occurred by the relocation of field items to fill in the eliminated items, by the addition of new field items, or in other suitable manners. For example, when items are shifted within the field after matched items are eliminated, the new configuration of items within the field may result in a match of three or more items in a row, column or other suitable configurations. Likewise, when new items are added to empty field spaces along the border of the field (such as at the top of the field), the new items may result in a match of three or more items in a row, column or other suitable configurations. If such a new match exists, the algorithm returns to 212, otherwise, the algorithm returns to 208.

If it is determined at 210 that a match of three or more items has not been created by replacement of the cursor item with the field space item, the algorithm proceeds to 220, where it is determined whether the user has placed a bomb object in a field space object. In one exemplary embodiment, a bomb object can be selected by the user by activating a control when a power up state has been achieved, a bomb object can be automatically provided to the user as the cursor item when a power up state has been achieved, or can be provided in other suitable manners. In addition, the user can acquire bomb objects during game play (such as by eliminating a treasure item), the user can be provided bomb objects as a daily bonus, the user can purchase bomb objects, or other suitable processes can be used to acquire bomb objects. A plurality of different types of bomb objects can also or alternatively be provided. If it is determined that a bomb object has not been placed in a field space object, the algorithm returns to 208, otherwise, the algorithm proceeds to 222.

At 222, one or more items are eliminated, depending on the type of bomb object that has been placed in the field space object. In one exemplary embodiment, the bomb object can include graphical, data and operational attributes, where the operational attributes can eliminate the item attribute for the field space object where it is placed, the bomb object can eliminate one or more item attributes in adjacent field space objects, or other suitable operational attributes can be associated with the bomb object. The algorithm then proceeds to 224, where items are shifted into any empty spaces created by the operation of the bomb object, and the algorithm then proceeds to 226, where new items are placed into any remaining empty spaces, as previously discussed. The algorithm then proceeds to 218.

During the execution of algorithm 200, if the timer object times out (such as by using a countdown timer with a predetermined number of seconds for play), the algorithm terminates and a final score is generated. Likewise, if a specialist or game award has been activated that provides for additional game play time, the additional time can be added, an extended time graphic can be generated, or other suitable processes can be implemented. Likewise, a specialist or game award can be provided that allows the user to make one or more additional cursor item swaps after the expiration of the game play timer prior to determination of the final score. The final score can also be adjusted by a multiplier, such as if the user has activated a specialist that provides a final score multiplier, if the user has eliminated a predetermined number of items, or in other suitable manners.

Although algorithm 200 has been described as a series of steps, algorithm 200 can also or alternatively be implemented as a state diagram or in other suitable manners. Likewise, although certain embodiments have been described in regards to object oriented programming implementations, other suitable programming types, languages, paradigms or regimes can also or alternatively be used.

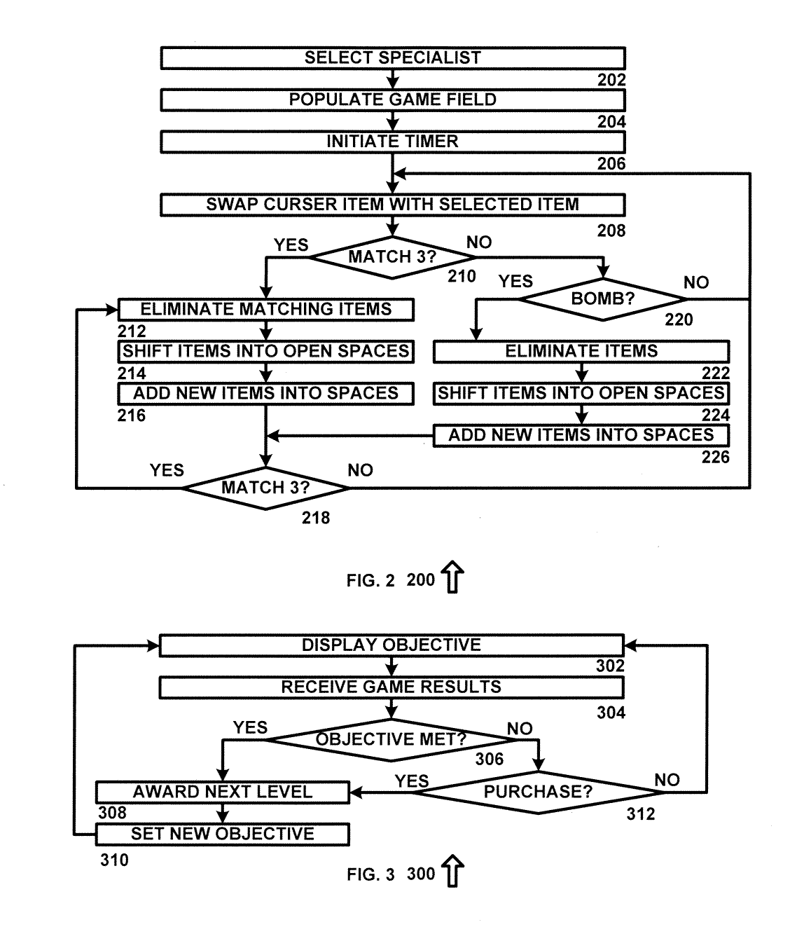

FIG. 3 is a diagram of an algorithm 300 for challenge mode gaming in accordance with an exemplary embodiment of the present disclosure. Algorithm 300 can be implemented in hardware or a suitable combination of hardware and software, such as one or more software systems operating on a general purpose processing platform.

Algorithm 300 begins at 302, where one or more challenge mode objectives are identified. In one exemplary embodiment, a graphic user interface can be generated after the user selects challenge mode play that identifies predetermined objectives for the challenge mode, such as the elimination of a predetermined number of items, the elimination of a predetermined number of a predetermined item type, or other suitable objectives. The algorithm then proceeds to 304, where the user plays the game, such as using algorithm 200 or in other suitable manners, and the game results are received. The algorithm then proceeds to 306.

At 306, it is determined whether the objective for the challenge mode has been achieved. In one exemplary embodiment, the challenge mode can include multiple objectives, and it can be determined which of the objectives has been achieved. For example, elimination of a first predetermined number of items can be defined as a first objective, and elimination of a second predetermined number of items can be defined as a second objective, or other suitable multiple objectives can defined. If it is determined that the objective has been met, the algorithm proceeds to 308, where a next level for challenge mode is awarded, in game awards are awarded, or where other suitable awards are provided. In one exemplary embodiment, a user may need to earn three stars to progress to the next challenge mode level, where obtaining a first score results in the user receiving one star, obtaining a second and higher score results in the user receiving two stars, and obtaining a third and highest score results in the user obtaining three stars. In addition, the user can be provided with in game awards for achieving the objective, such as in game currency, bomb items, collection items or other suitable in game awards. The algorithm then proceeds to 310.

At 310, a new objective or objectives are set, where suitable. In one exemplary embodiment, if a user has completed all requirements to proceed to a next level, the new objective or objectives can be associated with the next level. Likewise, where a user has not completed all of the requirements to proceed to the next level, the same objective or objectives for the current level can remain in effect until the user has completed all requirements. The algorithm then returns to 302.

If it is determined that an objective has not been met at 306, the algorithm proceeds to 312, where it is determined whether the user has elected to purchase the objective. In one exemplary embodiment, the user can purchase a free pass, such as to purchase a star, to make the objectives easier, or in other suitable manners. If it is determined that the user has elected to purchase the objective, the algorithm proceeds to 308, otherwise, the algorithm returns to 302.

Although algorithm 300 has been described as a series of steps, algorithm 300 can also or alternatively be implemented as a state diagram or in other suitable manners. Likewise, although certain embodiments have been described in regards to object oriented programming implementations, other suitable programming types, languages, paradigms or regimes can also or alternatively be used.

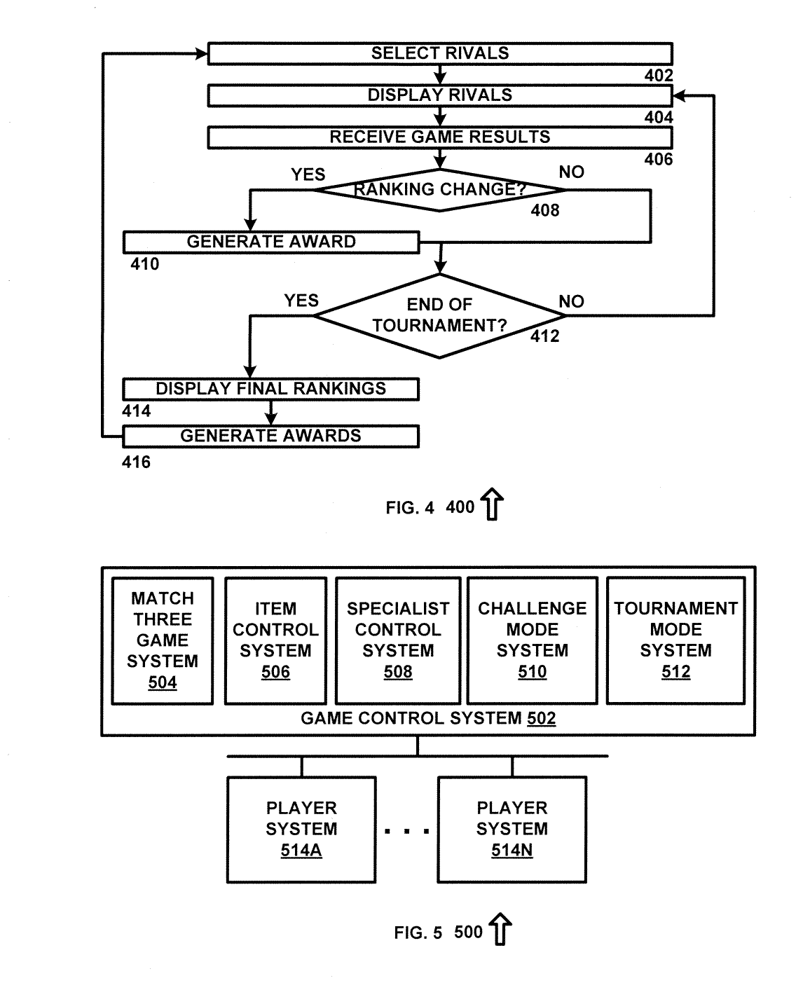

FIG. 4 is a diagram of an algorithm 400 for tournament mode gaming in accordance with an exemplary embodiment of the present disclosure. Algorithm 400 can be implemented in hardware or a suitable combination of hardware and software, such as one or more software systems operating on a general purpose processing platform.

Algorithm 400 begins at 402, where one or more rivals are selected. In one exemplary embodiment, rivals can be selected based on an experience level, where a group of players having similar experience levels are selected and identified as rivals. Likewise, rivals can be randomly selected, can be invited by a player, or other suitable processes can be used to select rivals. In addition, rivals can be re-selected on a periodic basis, such as once a week, based upon achievement of a tournament goal by one or more players, or in other suitable manners. The algorithm then proceeds to 404.

At 404, the rivals are displayed. In one exemplary embodiment, each rival can receive a notice of the tournament, the objective of the tournament (such as experience points, eliminated items or other suitable objectives), the available awards for winning the tournament, and the current standing of rivals, so as to create an incentive for each rival to participate in the tournament. The algorithm then proceeds to 406.

At 406, one or more rivals play a round of the game, and the results are received. In one exemplary embodiment, each rival can be allowed to play the game in tournament mode once a day, can be allowed to replay the game in tournament mode to try and achieve a higher score (such as where the player is allowed to keep the highest score achieved), can be allowed to replay the game in tournament to replace their current score (such as where the player must keep the new score even if it is lower than the previous score), can purchase an additional tournament mode game using in game currency, or other suitable processes can be used to allow each rival to participate in the tournament. After the game results for a period are received at 406, the algorithm proceeds to 408.

At 408, it is determined whether a ranking change has occurred. If it is determined that a ranking change has not occurred, the algorithm proceeds to 412. If it is determined that a ranking change has occurred, the algorithm proceeds to 410, where an award is generated. In one exemplary embodiment, awards can be in game currency, bomb items, collection items, or other suitable awards based upon a user's performance in tournament mode, such as based on a change in the user's standing relative to other users, the user or users that are currently in the top rankings, or in other suitable manners. The algorithm then proceeds to 412.

At 412, it is determined whether the tournament has ended. If it is determined that the tournament has not ended, the algorithm returns to 404, where rivals are displayed. In one exemplary embodiment, a graphic can be generated that displays a user's progress relative to other players, based upon each player's current performance in the tournament mode games. For example, where the experience points obtained in tournament mode games are used to rank players within the tournament, the graphic can indicate the relative rankings of each player based on each player's experience points. In this exemplary embodiment, experience points earned in tournament mode can be separate from the player's experience points earned during normal game play. If it is determined that the tournament has ended at 412, the algorithm proceeds to 414.

At 414, the final rankings for the tournament are displayed. In one exemplary embodiment, the final rankings can be generated after the expiration of the time period for the tournament, such as the next time that the user logs on to the gaming system. In another exemplary embodiment, the final ranking can be generated after each user has completed their last round of the game in tournament mode, or in other suitable manners. The algorithm then proceeds to 416.

At 416, awards are generated for tournament mode competitors. In one exemplary embodiment, the awards can include in game currency, bomb items, collection items or other suitable items, can be experience points that are added to the player's experience points for normal game play, or other suitable awards. The algorithm then returns to 402, where a new set of rivals are selected. In one exemplary embodiment, the new set of rivals can be different from the original set of rivals, such as where the players have earned additional experience points for normal game play that change their ranking relative to other players that were originally selected as rivals as well as players that were not originally selected as rivals.

Although algorithm 400 has been described as a series of steps, algorithm 400 can also or alternatively be implemented as a state diagram or in other suitable manners. Likewise, although certain embodiments have been described in regards to object oriented programming implementations, other suitable programming types, languages, paradigms or regimes can also or alternatively be used.

FIG. 5 is a diagram of a system 500 for controlling a game in accordance with an exemplary embodiment of the present disclosure. System 500 includes game control system 502, match three game system 504, item control system 506, specialist control system 508, challenge mode system 510, tournament mode system 512, and player systems 514A through 514N (where N is an integer greater than 1), each of which can be implemented as hardware or a suitable combination of hardware and software, and which can be one or more software systems operating on a processor.

Game control system 502 coordinates the activities of system 500, such as maintaining separate accounts for each player, interfacing the components of system 500 and other suitable activities. In one exemplary embodiment, game control system 502 can generate code that generates a graphic user interface on one or more of player systems 514A through 514N that simulates a lobby or other initial user interface, where players can select game activities from the lobby, such as by selecting one of a plurality of different worlds, cities or other suitable virtual environments within which to play the game activities provided by system 500. Game control system 502 can also store account data for each player, such as account data that uniquely identifies each player, security data for allowing a player to access their account, experience score data that is used to rank the player and to provide other game functionality as described herein, in game currency data that is used to identify specific currency items that are used to purchase in game functionality (such as specialists, collection items, access to virtual gaming areas or bomb items), general currency items that are owned by the player and that can be used to purchase game play, personalization items or that can be exchanged for specific currency items, and other suitable currency. Game control system 502 can also or alternatively be implemented in conjunction with a social networking website or system, so as to allow players to access game control system 502 through their social network account, to use social network account currency to purchase virtual game items, to allow users to provide alerts or notifications to other social network users regarding objectives achieved using game control system 502 (such as levels achieved, experience points awarded, challenge mode results, tournament mode results), or to perform other suitable functions.

Match three game system 504 provides a virtual match three game or other suitable games for use by a player. In one exemplary embodiment, a player can use currency to purchase rounds of game play from a virtual lobby or other virtual gaming environments. Match three game system 504 can interface with item control system 506, specialist control system 508, challenge mode system 510, tournament mode system 512 or other suitable systems, as described further herein.

Item control system 506 coordinates the generation and selection of items within match three game system. In one exemplary embodiment, item control system 506 can generate items for placement in a field prior to the start of game play, so as to ensure that items are randomly distributed within the field and that no matches of three or more items exist at the start of game play. Item control system 506 can also coordinate the award and use of special items, such as bomb items, treasure items, collection items or other suitable items. In addition, where each item is not independently controlled, such as by being implemented as one or more objects, item control system 506 can control the function of each item during game play, such as by checking the arrangement of items to determine whether three or more matching items are in a predetermined configuration (such as a horizontal or vertical line), to eliminate matching items, to shift items within the field to fill in empty spaces created by eliminated items, to generate new items for empty border spaces within the field that are created by the shifting of items, or in other suitable manners.

Specialist control system 508 allows users to obtain and use specialists for use during game play. In one exemplary embodiment, specialist control system 508 can coordinate with game control system 502 to determine whether a player has one or more specialist slots, whether a player is eligible to increase the number of specialist slots, or to otherwise control player access to specialist features of the game. Specialist control system 508 can further allow players to purchase a specialist, to use a specialist for a game, to trade specialists to other players or for other game items, or to perform other suitable functions. In one exemplary embodiment, prior to the start of a round of the game, a player can select one or more specialists for use during the game based on specialists that the player currently has in an inventory, such as specialists that cause an available match that can be formed using a cursor item to be highlighted, specialists that cause a bomb item to have an amplified effect, specialists that add time to a countdown timer or moves to a number of allotted moves for a game, specialists that increase the number of experience points that are awarded for removing items from the field during game play, specialists that increase the rate at which power ups are generated, specialists that cause items adjacent to spaces where a match has been formed to also be removed, or other suitable specialists.

Challenge mode system 510 allows a player to enter a challenge mode of game play, such as to allow the player to obtain additional experience points, in game awards, collection items, bomb items or other suitable virtual game advantages. In one exemplary embodiment, challenge mode system 510 can be accessed through a virtual game lobby, and can be purchased by a player using in game currency. Challenge mode system 510 can interface with match three game system 504 to allow a user to play a round of the match three game in order to achieve predetermined objectives, such as the elimination of a predetermined number of items, the elimination of a predetermined number of a predetermined type of item, or other suitable objectives. Challenge mode system 510 can coordinate with game control system 502 or other systems to generate awards for players that meet the predetermined objectives, such as to award additional experience points, to award access to virtual gaming areas, to award bomb items, to award currency, to award collection items, or to provide other suitable game advantages.

Tournament mode system 512 coordinates the activities of two or more players in tournament mode. In one exemplary embodiment, tournament mode system 512 can select a group of players for a tournament having a predetermined number of game rounds, a predetermined time period or other suitable constraints. In this exemplary embodiment, the group of players can be selected based on the experience points that have been earned by each player, such as to group players having a similar number of experience points in a tournament. Likewise, other suitable data can be used to select players, such as players having similar demographic data, players having similar in-game characteristics, players that are associated with the same or different teams, or other suitable data. Tournament mode system 512 can generate ranking data for display in a graphic user interface that displays the current ranking of players within the tournament, can generate award data for players during the tournament and at the completion of the tournament based upon one or more predetermined objectives for the tournament, and can perform other suitable functions as described herein.

Player systems 514A through 514N access and interface with game control system 502 and its associated systems, such as to interact with the virtual environment created by game control system 502, to play the match three game, to participate in challenge mode play or tournament mode play, to purchase account credits, game items or collection items, to interface with other players through social networking functionality, or in other suitable manners. Player systems 514A through 514N can be implemented using a web browser interface or application program of a general purpose processor or tablet computer, a web browser interface or application program for a cellular telephone or hand-held device, or on or in conjunction with other suitable devices.

In operation, system 500 allows multiple players to play a virtual match three game or other suitable games. In the virtual match three games, a field is initially generated using code that generates a user interface display, such as an eight by eight field of items such as gems, shapes, faces, objects or other suitable items. The user can be allotted a predetermined amount of time on a count-down timer, a predetermined number of moves, or other suitable parameters for determining when the game has finished. Likewise, the game can have a predetermined objective, such as a number of items to be eliminated, and the player can be scored based on the amount of time, the number of moves or other suitable parameters that were required in order to achieve the objective.

At the start of play, the player can have a cursor item that is selected from the set of items that are disposed in the field, and can exchange the cursor item with a field item, so as to assemble field items in groups to form matches. When three or more matching field items are in a predetermined arrangement, such as a vertical line or a horizontal line, the items can be eliminated, such as by generating an animation sequence that shows the items disappearing, turning to smoke, floating away, or in other suitable manners. After the items are eliminated, empty spaces will be formed in the field where the items were located. These empty spaces can then be filled by shifting items that are above the empty spaces downwards/upwards/leftward/rightward, by randomly selecting items to fill the empty spaces, or in other suitable manners. If the spaces are filled by shifting other items in the field, then empty spaces will remain at a border of the field, and these empty spaces can be filled with random items. The player can be awarded experience points for each item eliminated in this manner.

In addition to eliminating the matching items, a bomb item can be provided that eliminates items regardless of whether they are matching. In one exemplary embodiment, the bomb can be provided as a “power up,” where the user is awarded progress towards the power up by completing predetermined objectives, such as by matching three or more items. In this exemplary embodiment, after a player completes a first match, a power up meter can be incremented by a predetermined amount, such as one third. Likewise, as additional matches are completed, the power up meter can be incremented until it is at a maximum setting, at which point the player can use a bomb item, if the player owns a bomb item. The player can be provided with the bomb item automatically, can select the bomb item, can receive a random bomb item selection where a plurality of different bomb items are used, or can be provided with the bomb item in other suitable manners. The player can then select a space within the field to place the bomb item, and the bomb item can be detonated automatically, after a predetermined time period, or in other suitable manners.

Upon detonation, the bomb item can cause items in one or more field spaces to be eliminated, such as in conjunction with suitable graphical or animation sequences. In one exemplary embodiment, certain items such as X mark items (also known as brick items) can be immune to bombs, such that they are not eliminated. Following item elimination by a bomb item, the resulting empty spaces can be filled in the manner previously described. The player can also be awarded experience points for each item eliminated with a bomb item.

Brick items can be eliminated when they have migrated to the farthest border of the field, such as the bottom of the field when items move downward to fill in empty spaces, the left side of the field when items move leftward to fill in empty spaces and so forth. Likewise, brick items can be removed when matched, can be removed with special bomb items, or can have other properties.

In addition to normal items and brick items, treasure items and collection items can be used, such as where a treasure or in game award is awarded when the treasure item is eliminated with a bomb, where the collection item is eliminated with a bomb, or in other suitable manner.

In addition, players can be allowed to select one or more specialists to aid with game play. A specialist can cause the player to receive an experience point multiplier for each item removed, can cause bomb items to eliminate additional adjacent items, can cause items adjacent to matching items to be eliminated when the matching items are eliminated, or can provide other suitable game advantages. Likewise, specialists can add time to a countdown timer, can add additional moves where game play is limited by a number of moves, or can provide other suitable advantages.

When game play ends, such as when time on a countdown timer expires or when the player has used all available moves, a final score can be generated and added to a running total of experience points for the player. Likewise, additional post-game functionality can be provided, such as to allow the player to purchase additional time or moves, to allow the player to play an additional game (such as in tournament mode), or in other suitable manners.

In addition to standard game play, players can participate in challenge mode games, such as by paying for a challenge mode round using in game currency or in other manners. In challenge mode, the player can be provided with one or more objectives and can be awarded additional experience, in game awards such as currency or bomb items, or other suitable advantages in addition to normal game play when the objectives are satisfied. Likewise, in tournament mode, players can compete against other players for such additional advantages, additional experience or other awards.

Additional metagame functionality can be provided by defining virtual worlds, virtual rooms or other virtual gaming areas, where players earn access to these virtual gaming areas by earning experience points, by receiving in game awards that provide access to the virtual gaming areas, or in other suitable manners. In addition, levels can be provided within the virtual gaming areas, where obtaining a level results in additional awards of experience points or in game advantages.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims. Although certain embodiments may have been described in regards to object oriented programming implementations, other suitable programming types, languages, paradigms or regimes can also or alternatively be used.

What is claimed is:

1. A gaming system, comprising:
a graphic user interface generated by a processor for a display device, the graphic user interface further comprising:
a field having a N×M matrix of spaces, wherein N and M are integers greater than three, and wherein each space of the matrix includes one of a plurality of different items;
a cursor having an associated item and configured to allow a user to exchange a selected item from the field with the cursor item; and
wherein forming a predetermined arrangement of three or more identical items results in the items within the arrangement being removed from the field.

2. The gaming system of claim 1 wherein the graphic user interface is generated by a game control system, and the game control system further comprises a specialist control system configured to allow a user to select one of a plurality of specialists prior to initiating a game, wherein the selected specialist causes a change in the operation of the game.

3. The gaming system of claim 1 wherein the graphic user interface further comprises a bomb item that is configured to be placed within one of the spaces of the field and to cause one or more items of the field to be eliminated.

4. The gaming system of claim 1 wherein the graphic user interface is generated by a game control system, and the game control system further comprises a challenge mode system configured to allow a user to enter a challenge mode having a plurality of predetermined objectives and an award associated with each objective.

5. The gaming system of claim 1 wherein the graphic user interface is generated by a game control system, and the game control system further comprises a tournament mode system configured to allow a user to enter a tournament mode having a plurality of predetermined objectives and an award associated with each objective, and wherein the user competes against a plurality of other users to complete the predetermined objectives.

6. The gaming system of claim 1 wherein the graphic user interface further comprises:
a bomb item that is configured to be placed within one of the spaces of the field and to cause one or more items of the field to be eliminated;
a power up meter that is configured to receive a plurality of game action data types and increment a meter status indicator upon receipt of the game action data type; and
wherein the bomb item is enabled to be placed by the user when the meter status indicator has reached a maximum setting.

7. A method for controlling a game comprising:
electronically generating a virtual field of spaces using a processor, wherein the field is a matrix having dimensions N by M, where N and M are integers greater than three;
electronically selecting an item for each space of the field from a set of predetermined items stored in a memory device;
electronically starting a game timer;
receiving a user selection from a user input device of one of the field items using a cursor placed over the selected field item, wherein a location of the cursor is controlled using the user input device;
electronically replacing the field item with an item associated with the cursor;
electronically replacing the item associated with the cursor with the field item;
determining with the processor whether a predetermined arrangement of matching items is present in the field after replacing the field item with the item associated with the cursor; and
electronically removing the matching items in the predetermined arrangement if the predetermined arrangement of the matching items is present in the field after replacing the field item with the item associated with the cursor so as to form empty spaces in the field.

8. The method of claim 7 further comprising:
shifting one or more items in spaces adjacent to the empty spaces into the empty spaces; and
randomly generating a new item for each of the empty spaces.

9. The method claim 7 wherein electronically selecting an item for each space of the field from a set of predetermined items stored in a memory device comprises electronically setting an item type attribute for an object associated with each space.

10. The method of claim 7 further comprising electronically incrementing a power up meter by a predetermined amount in response to the number of matching items that have been removed.

11. The method of claim 10 further comprising:
electronically determining whether the power up meter has reached a maximum setting; and
enabling a bomb item if the power up meter has reached the maximum setting.

12. The method of claim 11 further comprising:
electronically associating the bomb item with the cursor; and
electronically replacing a second field item with the bomb item.

13. The method of claim 12 further comprising:
electronically simulating an explosion of the bomb item; and
electronically removing one or more items from the field after electronically simulating the explosion.

14. The method of claim 13 wherein electronically removing one or more items from the field after electronically simulating the explosion comprises:
electronically determining a bomb type for the bomb item;
electronically determining an operational attribute for the bomb type; and
applying the operational attribute to remove the one or more items from the field.

15. A system for controlling a game, comprising:
a plurality of space objects arranged in rows and columns to form a field, wherein each of the plurality of space objects includes an item type attribute and an operational attribute for monitoring each space object that is adjacent to the space object;
a cursor object configured to be controlled by a user interface device to be placed over any one of the plurality of space objects, the cursor object having an item type attribute and an operational attribute for causing the item type attribute of the space object that the cursor object is placed over to be exchanged for the item type attribute of the cursor object, and for causing the former item type attribute of the space object that the cursor object is placed over to be exchanged for the item type attribute of the cursor object.

16. The system of claim 15 wherein the operational attribute of a first space object for monitoring each space object that is adjacent to the first space object further comprises an operational attribute for changing the item type attribute of the first space object and the item type object of each space object that is adjacent to the first space object to an empty space item type attribute if a configuration of the first space object and each space object that is adjacent to the first space object is a predetermined configuration.

17. The system of claim 15 wherein the operational attribute of a first space object for monitoring each space object that is adjacent to the first space object further comprises an operational attribute for changing the item type attribute of the first space object from a first item type attribute to an empty space item type attribute if one of the adjacent space objects has an item type attribute that is the empty space item type attribute, and for changing the item type attribute of the adjacent space object to the first item type attribute.
